(19) United States
(12) Patent Application Publication
(10) Pub. No.: US 2026/0346738 A1
(43) Pub. Date: Nov. 5, 2026

(54) RAILROAD-CAR POWER-SUPPLY APPARATUS

(71) Applicant: Mitsubishi Electric Corporation, Chiyoda-ku, Tokyo (JP)

(72) Inventors: Hidenori SUZUKI, Tokyo (JP); Hiroki KAWAMOTO, Tokyo (JP)

(73) Assignee: Mitsubishi Electric Corporation, Chiyoda-ku, Tokyo (JP)

(21) Appl. No.: 18/997,600

(22) PCT Filed: Aug. 1, 2022
(86) PCT No.: PCT/JP2022/029502

§ 371 Date: Jan. 22, 2025

(51) Int. Cl. B60L 50/53; B60L 1/00

(52) U.S. Cl. CPC B60L 50/53; B60L 1/003; B60L 2200/26; B60L 2210/10; B60L 2210/30; B60L 2210/40

(57) ABSTRACT

A railroad-car power-supply apparatus is to be installed on a railroad car including a storage battery, the railroad-car power-supply apparatus including: a chopper circuit disposed on a primary side of a transformer; a first inverter disposed between the chopper circuit and the transformer; a resonance circuit disposed between the first inverter and the transformer; and a second inverter disposed between the transformer and a direct-current load. The chopper circuit performs step-down operation during normal traveling, and performs step-up operation during emergency traveling. The first inverter converts a direct-current voltage applied from the chopper circuit into an alternating-current voltage, and converts an alternating-current voltage applied from the primary side of the transformer into a direct-current voltage. The second inverter converts an alternating-current voltage applied from a secondary side of the transformer into a direct-current voltage, and converts a direct-current voltage applied from the storage battery into an alternating-current voltage.

### FIELD

The present disclosure relates to a railroad-car power-supply apparatus to be installed on a railroad car including a storage battery.

### BACKGROUND

Patent Literature 1 below discloses a railroad-car power-supply apparatus that converts direct-current power supplied from a direct-current overhead line into alternating-current power by means of an inverter, performs insulation by means of an LC filter and a commercial isolating transformer, the LC filter including a reactor and a capacitor, and then converts the alternating-current power into three-phase alternating-current power or single-phase alternating-current power of 50/60 [Hz] required for auxiliary machines such as an air conditioner and a display device. Note that the auxiliary machines refer to devices to be installed on a railroad car and supplied with electric power, other than a propulsion motor. Furthermore, in a railroad car, a power-supply apparatus that drives a propulsion motor is called a “main conversion apparatus” or the like, and is provided separately from a power-supply apparatus that supplies power to an auxiliary machine.

In addition, as a recent technical trend, there is a railroad car system in which a storage battery is installed, and power supply to an auxiliary machine can be continued by use of power of the storage battery in an emergency such as an overhead line power failure.

### CITATION LIST

### Patent Literature

Patent Literature 1: Japanese Patent Application Laid-open No. 2017-38424

### SUMMARY OF INVENTION

### Problem to be Solved by the Invention

There is also a need for use of power of a storage battery that supplies power to an auxiliary machine in an emergency, as power for emergency traveling. However, in the power-supply apparatus that supplies power to an auxiliary machine, power flows unidirectionally, that is, flows in a direction from an overhead line toward the auxiliary machine, as in the power-supply apparatus of Patent Literature 1 above. Therefore, the above-described need cannot be met.

The present disclosure has been made in view of the above, and an object of the present disclosure is to obtain a railroad-car power-supply apparatus capable of using, as power for emergency traveling, power of a storage battery that supplies power to an auxiliary machine.

### Means to Solve the Problem

In order to solve the above-described problem and achieve the object, a railroad-car power-supply apparatus according to the present disclosure is installed on a railroad car including a storage battery, and includes a transformer that insulates a primary side and a secondary side from each other. The railroad-car power-supply apparatus includes: a chopper circuit disposed on the primary side of the transformer; a first inverter disposed between the chopper circuit and the transformer; a resonance circuit including a resonant capacitor and disposed between the first inverter and the transformer; and a second inverter disposed between the transformer and a direct-current load. The chopper circuit performs step-down operation when power is supplied from an overhead line side, and performs step-up operation when power is supplied from the storage battery side. The first inverter converts a direct-current voltage applied from the chopper circuit into an alternating-current voltage, and applies the alternating-current voltage to the primary side of the transformer. The first inverter also converts an alternating-current voltage applied from the primary side of the transformer into a direct-current voltage, and applies the direct-current voltage to the chopper circuit. The resonance circuit performs series resonant operation by using a capacitance component of the resonant capacitor and an inductance component. The second inverter converts an alternating-current voltage applied from the secondary side of the transformer into a direct-current voltage, and applies the direct-current voltage to the direct-current load and the storage battery connected in parallel to the direct-current load. The second inverter also converts a direct-current voltage applied from the storage battery into an alternating-current voltage, and applies the alternating-current voltage to the secondary side of the transformer. The railroad-car power-supply apparatus is configured such that power can be supplied to an auxiliary machine by use of power from the overhead line during normal traveling, and power can be supplied to the auxiliary machine and a main motor by use of power from the storage battery during emergency traveling, the main motor being installed on the railroad car.

### Effects of the Invention

The railroad-car power-supply apparatus according to the present disclosure has an effect of enabling power of the storage battery that supplies power to the auxiliary machine, to be used as power for emergency traveling.

### BRIEF DESCRIPTION OF DRAWINGS

FIG. 1 is a diagram illustrating an exemplary configuration of a railroad car system including a power-supply apparatus according to an embodiment.

FIG. 2 is a diagram illustrating an exemplary configuration of a power supply main circuit which is a main circuit of the power-supply apparatus according to the embodiment.

FIG. 3 is a block diagram illustrating an exemplary hardware configuration for implementing functions of a control unit in the embodiment.

FIG. 4 is a block diagram illustrating another exemplary hardware configuration for implementing the functions of the control unit in the embodiment.

FIG. 5 is a diagram illustrating a configuration of a power-supply apparatus according to a first modification of the embodiment.

FIG. 6 is a diagram illustrating a configuration of a power-supply apparatus according to a second modification of the embodiment.

FIG. 7 is a diagram illustrating a configuration of a power-supply apparatus according to a third modification of the embodiment.

FIG. 8 is a diagram illustrating a configuration of a power-supply apparatus according to a fourth modification of the embodiment.

### DESCRIPTION OF EMBODIMENTS

A railroad-car power-supply apparatus (hereinafter, abbreviated as a “power-supply apparatus” as appropriate) according to an embodiment of the present disclosure will be described below in detail with reference to the accompanying drawings. Note that, in the following description, the term “connection” refers to both direct connection between constituent elements and indirect connection between constituent elements via another constituent element.

### Embodiment

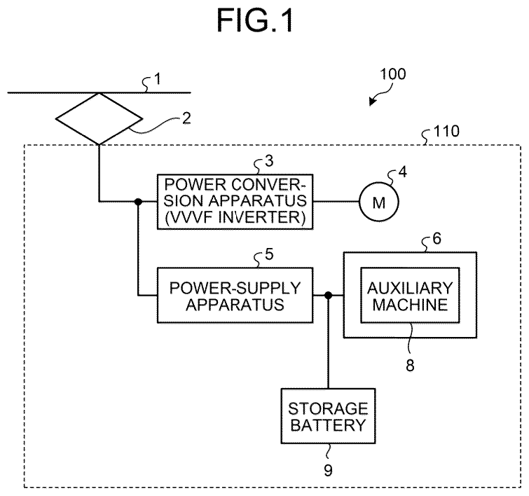

FIG. 1 is a diagram illustrating an exemplary configuration of a railroad car system 100 including a power-supply apparatus 5 according to an embodiment. The railroad car system 100 according to the embodiment includes a current collector 2, a power conversion apparatus 3, a main motor 4, the power-supply apparatus 5, a direct-current load 6, and a storage battery 9. These components are installed on a railroad car 110. The main motor 4 is a propulsion motor that applies propulsive force to the railroad car 110.

The current collector 2 collects direct-current power from an overhead line 1. The current collector 2 supplies the collected direct-current power to the power conversion apparatus 3. The power conversion apparatus 3 converts the direct-current power supplied from the current collector 2 into alternating-current power to the main motor 4. A VVVF inverter, which converts an applied direct-current voltage into an alternating-current voltage with a variable voltage value and a variable frequency, is used as the power conversion apparatus 3.

The current collector 2 also supplies the collected direct-current power to the power-supply apparatus 5. The power-supply apparatus 5 converts the direct-current power supplied from the current collector 2 into direct-current power to the direct-current load 6. The direct-current load 6 includes an auxiliary machine 8.

As described above, the auxiliary machine 8 is a load to be installed on the railroad car 110, other than the propulsion motor. Examples of the auxiliary machine 8 include a car interior lighting device, a door opening and closing device, an air conditioner, a safety device, a compressor, a storage battery, and a control power supply. The storage battery 9 is a large-capacity electric storage device, and is illustrated separately from the auxiliary machine 8 in FIG. 1. A car interior lighting device, a door opening and closing device, an air conditioner, a safety device, and a compressor, which are included in the examples of the auxiliary machine 8, are loads that operate by receiving supply of alternating-current power, and power is supplied to these loads via a three-phase inverter (not illustrated). In addition, a small-capacity storage battery, and a control power supply, which are included in the examples of the auxiliary machine 8, are loads that receive supply of direct-current power, and power is supplied to these loads via a charger (not illustrated), a direct current (DC)-DC converter, or the like.

The power-supply apparatus 5 according to the embodiment is configured such that power can be supplied to the auxiliary machine 8 by use of power from the overhead line 1 during normal traveling, and power can be supplied to the auxiliary machine 8 and the main motor 4 by use of power from the storage battery 9 during emergency traveling. The term “normal traveling” refers to traveling to be performed when power is supplied from the overhead line 1, and the term “emergency traveling” refers to traveling to be performed when power is not supplied from the overhead line 1 due to, for example, a power failure.

Since power can be supplied from the overhead line 1 during normal traveling, power is supplied to the auxiliary machine 8 by use of the power from the overhead line 1. Meanwhile, power supply from the overhead line 1 is interrupted during emergency traveling. Therefore, the power-supply apparatus 5 performs emergency traveling to a destination by using power stored in the storage battery 9 to drive the main motor 4 while supplying power stored in the storage battery 9 to the auxiliary machine 8. Note that emergency traveling may be performed by the power-supply apparatus 5 in a case where the power conversion apparatus 3 serving as a main conversion apparatus has failed. In the emergency traveling performed in this case, the railroad car 110 brought to an emergency stop can be moved to another place so as not to hinder other railroad cars from traveling.

Note that, in FIG. 1, an overhead conductor is illustrated as the overhead line 1, and a pantograph current collector is illustrated as the current collector 2, but the overhead line 1 and the current collector 2 are not limited thereto. The overhead line 1 may be a third rail to be used in subways and the like, and a current collector for the third rail may be used as the current collector 2 accordingly. Furthermore, although FIG. 1 illustrates a case where the overhead line 1 is a direct-current overhead line, the overhead line 1 may be an alternating-current overhead line. Note that when the overhead line 1 is an alternating-current overhead line, a main transformer is provided at a stage subsequent to the current collector 2, and a converter is provided at a stage subsequent to the main transformer. The main transformer is provided for stepping down a received alternating-current voltage. The converter converts an alternating-current voltage output from the main transformer into a direct-current voltage.

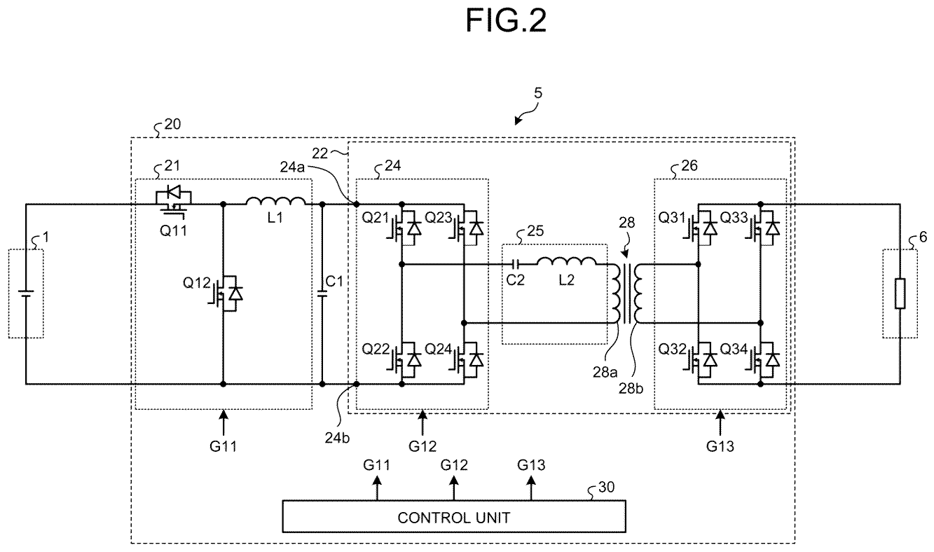

Next, a description will be given of a specific circuit configuration of the power-supply apparatus 5 according to the embodiment. FIG. 2 is a diagram illustrating an exemplary configuration of a power supply main circuit 20 which is a main circuit of the power-supply apparatus 5 according to the embodiment. The same constituent elements as those in FIG. 1 are denoted by the same reference numerals. As illustrated in FIG. 2, the power supply main circuit 20 includes a chopper circuit 21, a capacitor C1, a resonant DC-DC converter 22, and a control unit 30. The resonant DC-DC converter 22 includes a first inverter 24, a resonance circuit 25, a transformer 28, and a second inverter 26.

The transformer 28 is an isolating transformer including a primary winding 28a and a secondary winding 28b that are magnetically coupled to each other. In the present specification, a side connected to the primary winding 28a is referred to as a “primary side”, and a side connected to the secondary winding 28b is referred to as a “secondary side”.

The chopper circuit 21 is disposed on the primary side of the transformer 28. The chopper circuit 21 includes a first reactor L1, a first switching element Q11, and a second switching element Q12.

The first inverter 24 is disposed between the chopper circuit 21 and the transformer 28 on the primary side of the transformer 28. The first inverter 24 includes four bridge-connected switching elements, that is, third to sixth switching elements Q21 to Q24. A connection point between the third switching element Q21 and the fifth switching element Q23 is drawn outside to form a first direct-current terminal 24a, and a connection point between the fourth switching element Q22 and the sixth switching element Q24 is drawn outside to form a second direct-current terminal 24b.

In the chopper circuit 21, one end of the first reactor L1 is connected to the first direct-current terminal 24a of the first inverter 24. One end of the first switching element Q11 is connected to another end of the first reactor L1, and another end of the first switching element Q11 is connected to an overhead line 1 side. One end of the second switching element Q12 is connected to the another end of the first reactor L1, and another end of the second switching element Q12 is connected to the second direct-current terminal 24b of the first inverter.

A positive side of the capacitor C1 is connected to the first direct-current terminal 24a, and a negative side of the capacitor C1 is connected to the second direct-current terminal 24b, between the chopper circuit 21 and the first inverter 24. The capacitor C1 connected in this manner is provided so as to smooth a direct-current voltage output from the chopper circuit 21 and a direct-current voltage output from the first inverter 24.

The resonance circuit 25 is disposed between the first inverter 24 and the transformer 28. The resonance circuit 25 includes a resonant capacitor C2 and a second reactor L2. The resonance circuit 25 performs series resonant operation by using a capacitance component of the resonant capacitor C2 and an inductance component of the second reactor L2. That is, the second reactor L2 acts as an inductance component in the resonance circuit 25. Note that leakage inductance of the transformer 28 may be used instead of the second reactor L2. In this case, the second reactor L2 can be omitted.

The second inverter 26 is disposed between the transformer 28 and the direct-current load 6, on the secondary side of the transformer 28. The second inverter 26 includes four bridge-connected switching elements, that is, seventh to tenth switching elements Q31 to Q34.

The first and second switching elements Q11 and Q12, the third to sixth switching elements Q21 to Q24, and the seventh to tenth switching elements Q31 to Q34 are, for example, metal-oxide-semiconductor field-effect transistor (MOSFETs) illustrated in the drawing, but may be insulated gate bipolar transistors (IGBTs) or transistor elements other than the IGBTs.

Each of the first and second switching elements Q11 and Q12, the third to sixth switching elements Q21 to Q24, and the seventh to tenth switching elements Q31 to Q34 includes a diode connected in an inverse-parallel connection. The term “inverse-parallel connection” means that a first terminal corresponding to a drain of a MOSFET is connected to a cathode of a diode, and a second terminal corresponding to a source of the MOSFET is connected to an anode of the diode.

In addition, the first and second switching elements Q11 and Q12, the third to sixth switching elements Q21 to Q24, and the seventh to tenth switching elements Q31 to Q34 are generally formed by use of a silicon (Si)-based semiconductor made of silicon in most cases, but may be formed by use of a wide bandgap semiconductor made of silicon carbide (SiC), gallium nitride (GaN), gallium oxide (Ga₂O₃), diamond, or the like. When the switching elements are each formed of a wide bandgap semiconductor-based material, it is possible to achieve low loss and high-speed switching.

The control unit 30 generates a switching signal G11 for controlling the first and second switching elements Q11 and Q12 of the chopper circuit 21 on the basis of a detection signal from a sensor (not illustrated), and outputs the switching signal G11 to the chopper circuit 21. In addition, the control unit 30 generates a switching signal G12 for controlling the third to sixth switching elements Q21 to Q24 of the first inverter 24 on the basis of a detection signal from a sensor (not illustrated), and outputs the switching signal G12 to the second inverter 26. Furthermore, the control unit 30 generates a switching signal G13 for controlling the seventh to tenth switching elements Q31 to Q34 of the second inverter 26 on the basis of a detection signal from a sensor (not illustrated), and outputs the switching signal G13 to the second inverter 26.

As described above, the power-supply apparatus 5 according to the embodiment is a railroad-car power-supply apparatus that is installed on the railroad car 110 including the storage battery 9, and includes the transformer 28. The transformer 28 includes the primary winding 28a and the secondary winding 28b, which are magnetically coupled to each other, and insulates the primary side and the secondary side from each other.

Next, operation of the power-supply apparatus 5 according to the embodiment will be described. The chopper circuit 21 performs step-down operation or through operation when power is supplied from the overhead line 1, and performs step-up operation when power is supplied from the storage battery 9. That is, the chopper circuit 21 performs step-down operation or through operation during normal traveling, and performs step-up operation during emergency traveling. The through operation is operation to be performed when the second switching element Q12 is constantly off. In the through operation, the voltage of the overhead line 1 is applied to the capacitor C1 via the first switching element Q11 and the first reactor L1 without being stepped down.

Note that, in the step-down operation of the chopper circuit 21, a current flow path is secured by the diode connected in an inverse-parallel connection, so that the second switching element Q12 need not perform turn-on operation. Meanwhile, synchronous rectification may be performed for causing the second switching element Q12 to perform turn-on operation at a timing when current flows through the diode connected in an inverse-parallel connection. Since a voltage drop due to the on-resistance of a transistor is smaller than a voltage drop in a forward direction of a diode, it is possible to reduce loss in the chopper circuit 21 by performing synchronous rectification.

The capacitor C1 smooths and holds a direct-current voltage output from the chopper circuit 21. The capacitor C1 also smooths and holds a direct-current voltage output from the first inverter 24.

The first inverter 24 converts a direct-current voltage applied from the chopper circuit 21 into an alternating-current voltage, and applies the alternating-current voltage to the primary side of the transformer 28. The first inverter 24 also converts an alternating-current voltage applied from the primary side of the transformer 28 into a direct-current voltage, and applies the direct-current voltage to the chopper circuit 21. The first inverter 24 operates as an inverter circuit during normal traveling, and operates as a rectifier circuit during emergency traveling.

During normal traveling, the third to sixth switching elements Q21 to Q24 included in the first inverter 24 each operate in such a way as to achieve a conduction ratio of 50%. At the time of this operation, two of the third to sixth switching elements Q21 to Q24 simultaneously perform switch-on or switch-off, the two of the third to sixth switching elements Q21 to Q24 being diagonally opposite to each other. That is, a set of the third and sixth switching elements Q21 and Q24 simultaneously performs switch-on or switch-off, and a set of the fourth and fifth switching elements Q22 and Q23 simultaneously performs switch-on or switch-off. Note that it goes without saying that in switching control, a dead time is provided for preventing series-connected switching elements from simultaneously performing switch-on due to variation in circuit operation, that is, preventing a set of the third and fourth switching elements Q21 and Q22 from simultaneously performing switch-on due to variation in circuit operation and preventing a set of the fifth and sixth switching elements Q23 and Q24 from simultaneously performing switch-on due to variation in circuit operation. The conduction ratio of 50% described here refers to a conduction ratio to be obtained before the dead time is provided.

As described above, in the resonance circuit 25, series resonant operation is performed by use of the capacitance component of the resonant capacitor C2 and the inductance component of the second reactor L2. As a result of this series resonant operation, resonance current flows through the resonance circuit 25. Since each of the third to sixth switching elements Q21 to Q24 is controlled in such a way as to achieve a conduction ratio of 50%, it is possible to switch between turn-on operation of the set of the third and sixth switching elements Q21 and Q24 and turn-on operation of the set of the fourth and fifth switching elements Q22 and Q23 by using a zero point at which the resonance current becomes zero. This operation is an example of a soft switching method, and is called “zero current switching”. As a result, since switching loss can be reduced in the third to sixth switching elements Q21 to Q24, it is possible to allow the first inverter 24 to perform low-loss operation.

Note that, at the time of emergency traveling, power flows in a direction from the resonance circuit 25 toward the chopper circuit 21 in the first inverter 24, and a current flow path is secured by the diodes connected in an inverse-parallel connection, so that the third to sixth switching elements Q21 to Q24 need not perform turn-on operation. Meanwhile, synchronous rectification may be performed for causing a corresponding switching element to perform turn-on operation at a timing when current flows through a diode connected in an inverse-parallel connection. It is possible to reduce loss in the first inverter 24 by performing synchronous rectification.

In addition, during emergency traveling, a voltage applied to the capacitor C1 via the first inverter 24 is controlled by adjustment to a boosting ratio of the chopper circuit 21. In this way, even when the voltage of the capacitor C1 is adjusted to a desired voltage, the conduction ratios of the third to sixth switching elements Q21 to Q24 can be maintained at 50%. As a result, even when the voltage of the capacitor C1 is adjusted to a desired voltage, it is possible to reduce switching loss in the first inverter 24.

The second inverter 26 converts an alternating-current voltage applied from the secondary side of the transformer 28 into a direct-current voltage, and applies the direct-current voltage to the direct-current load 6 and the storage battery 9 connected in parallel to the direct-current load 6. The second inverter 26 also converts a direct-current voltage applied from the storage battery 9 into an alternating-current voltage, and applies the alternating-current voltage to the secondary side of the transformer 28. The second inverter 26 operates as a rectifier circuit during normal traveling, and operates as an inverter circuit during emergency traveling.

As described above, the power-supply apparatus 5 according to the embodiment is configured such that power can be supplied to the auxiliary machine 8 by use of power from the overhead line 1 during normal traveling, and power can be supplied to the auxiliary machine 8 and the main motor 4, which is installed on the railroad car 110, by use of power from the storage battery 9 during emergency traveling. As a result, the power-supply apparatus 5 according to the embodiment can use power of the storage battery 9, which supplies power to the auxiliary machine 8, as power for emergency traveling.

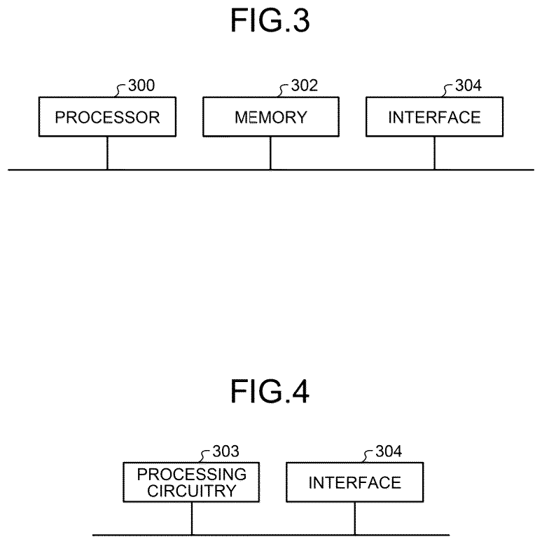

FIG. 3 is a block diagram illustrating an exemplary hardware configuration for implementing functions of the control unit 30 in the embodiment. In a case where the functions of the control unit 30 in the embodiment are implemented, the control unit 30 may include a processor 300, a memory 302, and an interface 304 as illustrated in FIG. 3. The processor 300 performs computation. A program to be read by the processor 300 is stored in the memory 302. The interface 304 implements input and output of signals.

The processor 300 is an example of a computing means. The processor 300 may be a computing means called a microprocessor, a microcomputer, a microcontroller, a central processing unit (CPU), or a digital signal processor (DSP). Furthermore, examples of the memory 302 include a nonvolatile or volatile semiconductor memories such as a random access memory (RAM), a read only memory (ROM), a flash memory, an erasable programmable ROM (EPROM), and an electrically EPROM (EEPROM (registered trademark)), a magnetic disk, a flexible disk, an optical disk, a compact disc, a mini disc, and a digital versatile disc (DVD).

Programs for executing the functions of the control unit 30 in the embodiment are stored in the memory 302. The processor 300 can perform the above-described processing by exchanging necessary information via the interface 304 and executing the programs stored in the memory 302. Results of computation performed by the processor 300 can be stored in the memory 302.

Furthermore, the functions of the control unit 30 in the embodiment may be implemented by a configuration illustrated in FIG. 4. FIG. 4 is a block diagram illustrating another exemplary hardware configuration for implementing the functions of the control unit 30 in the embodiment. In FIG. 4, the processor 300 and the memory 302 illustrated in FIG. 3 have been replaced with processing circuitry 303. The processing circuitry 303 corresponds to a single circuit, a composite circuit, an application specific integrated circuit (ASIC), a field-programmable gate array (FPGA), or a combination thereof. Information input to the processing circuitry 303 and information output from the processing circuitry 303 can be received and transmitted via the interface 304, respectively.

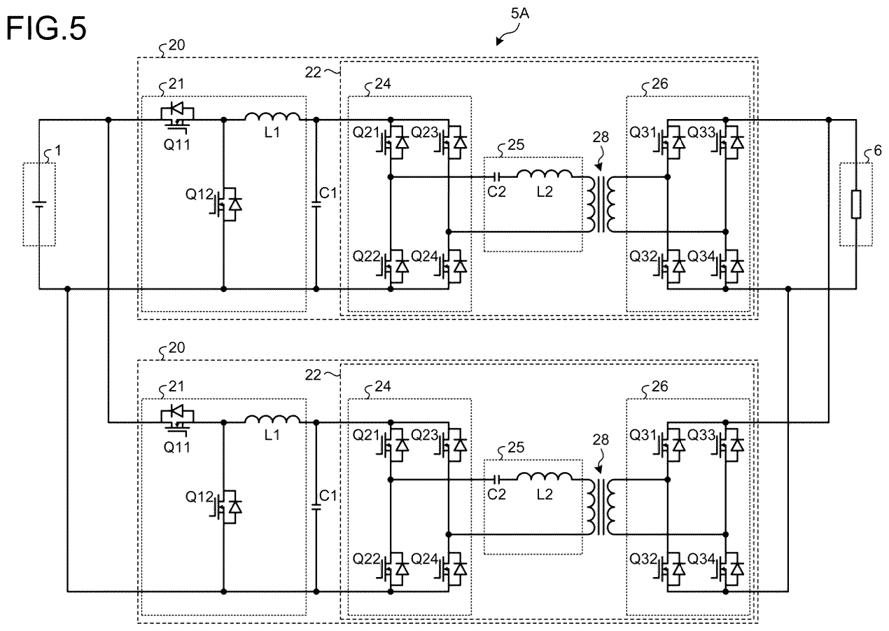

Next, modifications of the power-supply apparatus 5 according to the embodiment will be described. FIG. 5 is a diagram illustrating a configuration of a power-supply apparatus 5A according to a first modification of the embodiment. The configuration in which the power-supply apparatus 5 includes a single power supply main circuit 20 has been described in FIG. 2. Meanwhile, in the power-supply apparatus 5A illustrated in FIG. 5, two power supply main circuits 20 are connected in parallel to the overhead line 1 and the direct-current load 6. Note that the configuration illustrated in FIG. 5 is an example, and the number of power supply main circuits 20 connected in parallel may be three or more.

In the configuration of the power-supply apparatus 5A illustrated in FIG. 5, interleave operation is applied to the two power supply main circuits 20. The term “interleave operation” refers to operation of causing the power supply main circuits 20 to operate in a state where the power supply main circuits 20 are out of phase with each other in one cycle of processing. For example, when the number of power supply main circuits 20 is two, the power supply main circuits 20 are caused to operate in a state where the power supply main circuits 20 are out of phase with each other by 180 degrees, and when the number of power supply main circuits 20 is four, the power supply main circuits 20 are caused to operate in a state where the power supply main circuits 20 are out of phase with each other by 90 degrees. When the power supply main circuits 20 are caused to perform interleave operation, ripples of voltage in the circuits can be reduced. Thus, the capacitance of the capacitor C1 can be reduced.

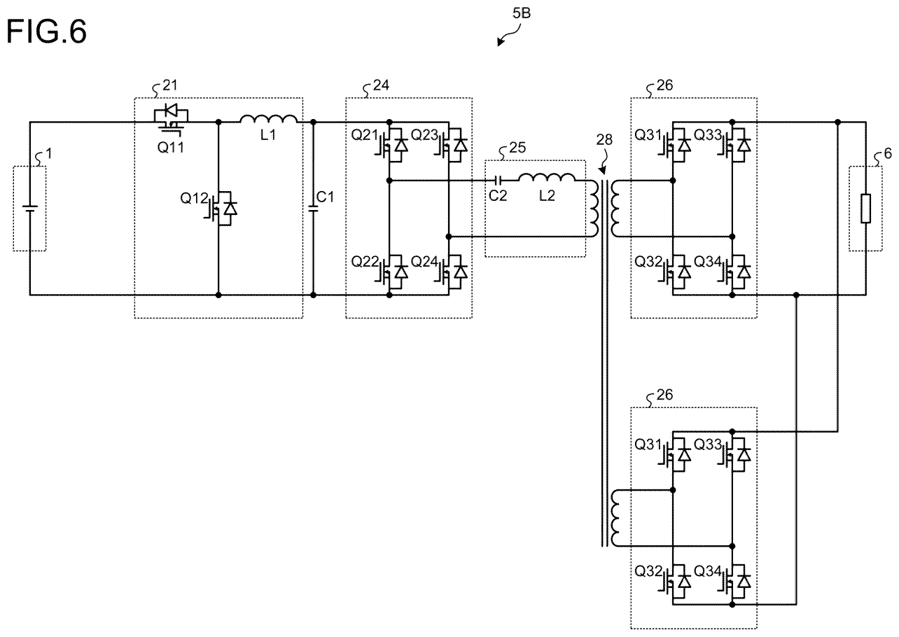

FIG. 6 is a diagram illustrating a configuration of a power-supply apparatus 5B according to a second modification of the embodiment. In FIG. 5, all the chopper circuits 21, the first inverters 24, the resonance circuits 25, the transformers 28, and the second inverters 26 in the power supply main circuits 20 are connected in parallel. Meanwhile, only the second inverters 26 may be connected in parallel as illustrated in FIG. 6. Even with such a configuration, interleave operation can be performed, and it is possible to obtain an effect equivalent to that of the power-supply apparatus 5A according to the first modification.

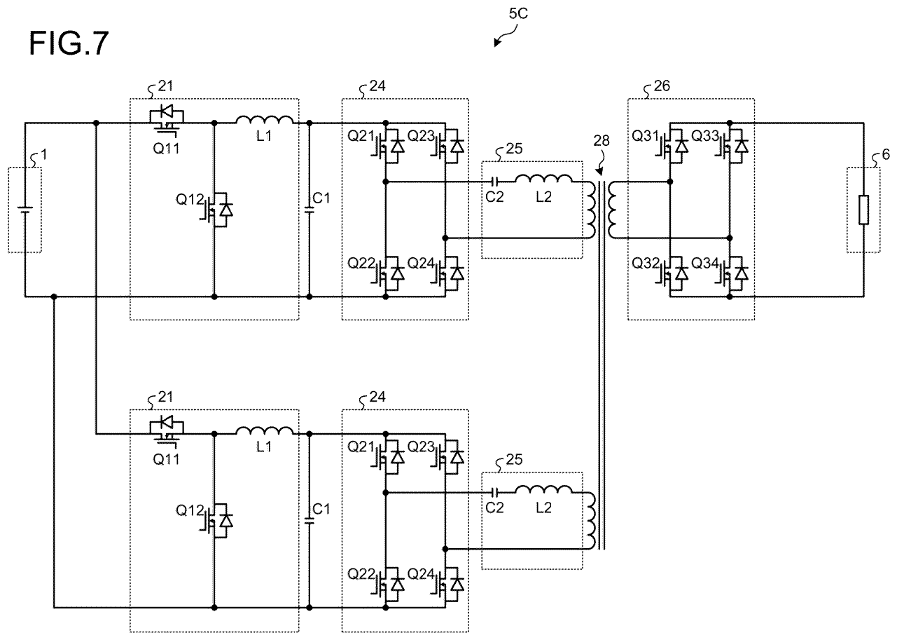

Furthermore, FIG. 7 is a diagram illustrating a configuration of a power-supply apparatus 5C according to a third modification of the embodiment. In FIG. 6, only the second inverters 26 are connected in parallel. Meanwhile, three constituent elements other than the second inverter 26, that is, the chopper circuits 21, the first inverters 24, and the resonance circuits 25 may be connected in parallel as illustrated in FIG. 7. Even with such a configuration, interleave operation can be performed, and it is possible to obtain an effect equivalent to that of the power-supply apparatus 5A according to the first modification and the power-supply apparatus 5B according to the second modification.

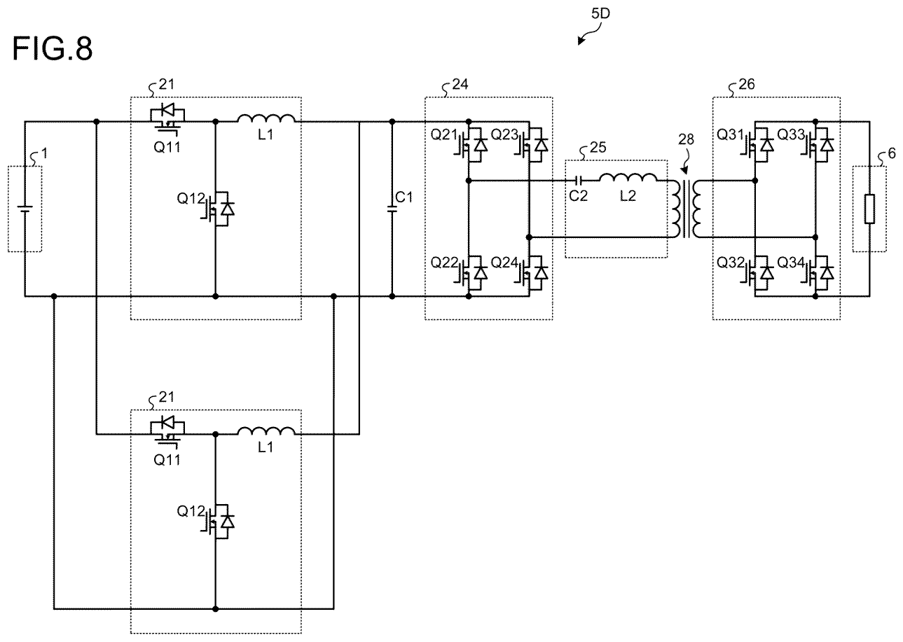

In addition, FIG. 8 is a diagram illustrating a configuration of a power-supply apparatus 5D according to a fourth modification of the embodiment. In FIG. 7, the three constituent elements, that is, the chopper circuits 21, the first inverters 24, and the resonance circuits 25 are connected in parallel. Meanwhile, only the chopper circuits 21 may be connected in parallel as illustrated in FIG. 8. Even with such a configuration, interleave operation can be performed, and it is possible to obtain an effect equivalent to that of the power-supply apparatus 5A according to the first modification, the power-supply apparatus 5B according to the second modification, and the power-supply apparatus 5C according to the third modification.

As described above, the railroad-car power-supply apparatus according to the embodiment is installed on a railroad car including a storage battery, and includes a transformer that insulates a primary side and a secondary side from each other. The power-supply apparatus includes: a chopper circuit disposed on the primary side of the transformer; a first inverter disposed between the chopper circuit and the transformer; a resonance circuit including a resonant capacitor and disposed between the first inverter and the transformer; and a second inverter disposed between the transformer and a direct-current load. The chopper circuit performs step-down operation when power is supplied from an overhead line side, and performs step-up operation when power is supplied from a storage battery side. The first inverter converts a direct-current voltage applied from the chopper circuit into an alternating-current voltage, and applies the alternating-current voltage to the primary side of the transformer. The first inverter also converts an alternating-current voltage applied from the primary side of the transformer into a direct-current voltage, and applies the direct-current voltage to the chopper circuit. The resonance circuit performs series resonant operation by using a capacitance component of the resonant capacitor and an inductance component. The second inverter converts an alternating-current voltage applied from the secondary side of the transformer into a direct-current voltage, and applies the direct-current voltage to the direct-current load and the storage battery connected in parallel to the direct-current load. The second inverter also converts a direct-current voltage applied form the storage battery into an alternating-current voltage, and applies the alternating-current voltage to the secondary side of the transformer. With the above-described constituent elements, the railroad-car power-supply apparatus is configured such that power can be supplied to an auxiliary machine by use of power from an overhead line during normal traveling, and power can be supplied to the auxiliary machine and a main motor by use of power from the storage battery during emergency traveling, the main motor being installed on the railroad car. As a result, it is possible to obtain a railroad-car power-supply apparatus capable of using, as power for emergency traveling, power of a storage battery that supplies power to an auxiliary machine.

Note that, in the above-described configuration, the chopper circuit may include: a first reactor having one end connected to a first direct-current terminal of the first inverter; a first switching element having one end connected to another end of the first reactor, and another end connected to the overhead line side; and a second switching element having one end connected to the another end of the first reactor, and another end connected to a second direct-current terminal of the first inverter, wherein the second switching element includes a diode connected in an inverse-parallel connection. In this configuration, when the chopper circuit performs step-down operation, synchronous rectification operation may be performed for causing the second switching element to perform turn-on operation at a timing when current flows through the diode connected in an inverse-parallel connection. This allows loss in the chopper circuit to be reduced.

Furthermore, in the above configuration, it is possible to cause each of the third to sixth switching elements included in the first inverter to operate in such a way as to achieve a conduction ratio of 50%, and cause two of the third to sixth switching elements to simultaneously perform switch-on or switch-off, the two of the third to sixth switching elements being diagonally opposite to each other. With this operation, it is possible to reduce switching loss in the third to sixth switching elements, so that the first inverter can perform low-loss operation.

Furthermore, in the above-described configuration, a capacitor that smooths a direct-current voltage output from the chopper circuit or a direct-current voltage output from the first inverter can be provided between the chopper circuit and the first inverter. In this configuration, a voltage applied to the capacitor via the first inverter is controlled by adjustment to the boosting ratio of the chopper circuit. In this way, even when the voltage of the capacitor C1 is adjusted to a desired voltage, the conduction ratios of the third to sixth switching elements Q21 to Q24 can be maintained at 50%, so that switching loss in the first inverter 24 can be reduced.

The configurations set forth in the above embodiment show examples, and it is possible to combine the configurations with another known technique, and is also possible to partially omit or change the configurations without departing from the scope of the present disclosure.

### REFERENCE SIGNS LIST

1 overhead line; 2 current collector; 3 power conversion apparatus; 4 main motor; 5, 5A, 5B, 5C, 5D power-supply apparatus; 6 direct-current load; 8 auxiliary machine; 9 storage battery; 20 power supply main circuit; 21 chopper circuit; 22 resonant DC-DC converter; 24 first inverter; 24a first direct-current terminal; 24b second direct-current terminal; 25 resonance circuit; 26 second inverter; 28 transformer; 28a primary winding; 28b secondary winding; 30 control unit; 100 railroad car system; 110 railroad car; 300 processor; 302 memory; 303 processing circuitry; 304 interface; C1 capacitor; C2 resonant capacitor; G11 to G13 switching signal; L1 first reactor; L2 second reactor; Q11 first switching element; Q12 second switching element; Q21 third switching element; Q22 fourth switching element; Q23 fifth switching element; Q24 sixth switching element; Q31 seventh switching element; Q32 eighth switching element; Q33 ninth switching element; Q34 tenth switching element.

1. A railroad-car power-supply apparatus to be installed on a railroad car including a storage battery, the railroad-car power-supply apparatus including a transformer to insulate a primary side and a secondary side from each other, the railroad-car power-supply apparatus comprising:
a chopper circuit disposed on the primary side of the transformer, the chopper circuit performing step-down operation when power is supplied from an overhead line side and performing step-up operation when power is supplied from the storage battery side;
a first inverter disposed between the chopper circuit and the transformer, the first inverter converting a direct-current voltage applied from the chopper circuit into an alternating-current voltage and applying the alternating-current voltage to the primary side of the transformer, the first inverter converting an alternating-current voltage applied from the primary side of the transformer into a direct-current voltage and applying the direct-current voltage to the chopper circuit;
a resonance circuit including a resonant capacitor and being disposed between the first inverter and the transformer, the resonance circuit performing series resonant operation by using a capacitance component of the resonant capacitor and an inductance component; and
a second inverter disposed between the transformer and a direct-current load, the second inverter converting an alternating-current voltage applied from the secondary side of the transformer into a direct-current voltage and applying the direct-current voltage to the direct-current load and the storage battery connected in parallel to the direct-current load, the second inverter converting a direct-current voltage applied from the storage battery into an alternating-current voltage and applying the alternating-current voltage to the secondary side of the transformer, wherein
power can be supplied to an auxiliary machine by use of power from the overhead line during normal traveling, and
power can be supplied to the auxiliary machine and a main motor by use of power from the storage battery during emergency traveling, the main motor being installed on the railroad car.

2. The railroad-car power-supply apparatus according to claim 1, wherein
the chopper circuit
performs the step-down operation or through operation during normal traveling, and
performs the step-up operation during emergency traveling.

3. The railroad-car power-supply apparatus according to claim 1, wherein
the chopper circuit includes:
a first reactor having one end connected to a first direct-current terminal of the first inverter;
a first switcher having one end and another end, the one end of the first switcher being connected to another end of the first reactor, the another end of the first switcher being connected to the overhead line side; and
a second switcher having one end and another end, the one end of the second switcher being connected to the another end of the first reactor, the another end of the second switcher being connected to a second direct-current terminal of the first inverter, wherein
the first and second switchers each include a diode connected in an inverse-parallel connection, and
in a case where the chopper circuit performs the step-down operation, the second switcher performs turn-on operation at a timing when current flows through the diode connected in an inverse-parallel connection.

4. The railroad-car power-supply apparatus according to claim 1, comprising:
a second reactor disposed between the first inverter and the transformer, wherein
the second reactor acts as the inductance component in the resonance circuit.

5. The railroad-car power-supply apparatus according to claim 1, wherein
the first inverter includes third to sixth switchers that are full-bridge connected,
the third to sixth switchers each include a diode connected in an inverse-parallel connection, and
the first inverter
operates as an inverter circuit during normal traveling, and
operates as a rectifier circuit during emergency traveling.

6. The railroad-car power-supply apparatus according to claim 5, wherein
the third to sixth switchers each operate in such a way as to achieve a conduction ratio of 50%, and two of the third to sixth switchers simultaneously perform switch-on or switch-off, the two of the third to sixth switchers being diagonally opposite to each other.

7. The railroad-car power-supply apparatus according to claim 6, comprising:
a capacitor disposed between the chopper circuit and the first inverter, the capacitor smoothing a direct-current voltage output from the chopper circuit or a direct-current voltage output from the first inverter, wherein
a voltage to be applied to the capacitor via the first inverter is controlled by adjustment to a boosting ratio of the chopper circuit.

8. The railroad-car power-supply apparatus according to claim 1, wherein
the second inverter includes seventh to tenth switchers that are full-bridge connected,
the seventh to tenth switchers each include a diode connected in an inverse-parallel connection, and
the second inverter
operates as a rectifier circuit during normal traveling, and
operates as an inverter circuit during emergency traveling.
